(19) United States
(12) Patent Application Publication
(10) Pub. No.: US 2021/0175676 A1
(43) Pub. Date: Jun. 10, 2021

(54) LASER APPARATUS, RESIN DEGRADATION DETECTION METHOD, AND DETECTION METHOD OF OPTICAL POWER

(71) Applicant: FUJIKURA LTD., Tokyo (JP)

(72) Inventor: Naoyuki Sugiyama, Sakura-shi, Chiba (JP)

(73) Assignee: FUJIKURA LTD., Tokyo (JP)

(21) Appl. No.: 17/267,766

(22) PCT Filed: Sep. 24, 2019
(86) PCT No.: PCT/JP2019/037240

§ 371 Date: Feb. 10, 2021

(30) Foreign Application Priority Data
Oct. 10, 2018 (JP) 2018-191689

(51) Int. Cl. H01S 3/00; H01S 3/08; H01S 3/067; G01N 29/14

(52) U.S. Cl. CPC H01S 3/0014; H01S 3/08013; G01N 2291/0235; G01N 29/14; H01S 3/06704

(57) ABSTRACT

A laser apparatus includes: an optical fiber through which a laser beam propagates; a resin that fixes the optical fiber; a sound sensor that detects a sound produced by the resin that shrinks when a power of light propagating through the optical fiber decreases from its peak value; a storage that stores a threshold relating to a sound produced when the resin shrinks; and a comparison determination part. The comparison determination part compares a detected value representative of the sound detected by the sound sensor to the threshold stored in the storage and determines that the resin has been degraded when the detected value exceeds the threshold.

### CROSS-REFERENCE TO RELATED APPLICATIONS

This is a U.S. National Stage application of International Application No. PCT/JP2019/037240 filed Sep. 24, 2019, which claims priority from Japanese patent application No. 2018-191689 filed Oct. 10, 2018. These references are incorporated herein in their entirety by reference.

### BACKGROUND

### Technical Field

The present invention relates to a laser apparatus, a resin degradation detection method, and a detection method of an optical power, and more particularly to a method of detecting degradation of a resin that fixes an optical fiber in place, for example in a laser apparatus.

### Description of Related Art

There has heretofore been known a laser apparatus having a process head that delivers a laser beam, for example, from a fiber laser to a workpiece to process the workpiece (see, e.g., Patent Literature 1). With such a laser apparatus, when a workpiece is formed of a material having a high reflectivity (for example, copper or gold), a delivered laser beam is reflected from the workpiece at a high ratio. Therefore, the reflected light may return to an interior of the laser apparatus through the process head.

If the amount of light returning to the laser apparatus increases, one or more components within the laser apparatus (e.g., an output combiner) generates heat by the optical feedback, resulting in a damaged optical fiber or a failure such as a disconnected optical path. In order to prevent such a failure, there has been proposed a method of detecting an optical feedback propagating in a laser apparatus and stopping an operation of the laser apparatus if the amount of the optical feedback exceeds a predetermined threshold.

However, if such an optical feedback repetitively returns to the laser apparatus, a portion of the optical feedback is absorbed in a resin that fixes an optical fiber or the like. Thus, the resin is degraded gradually. As a result, a failure may be caused from a portion of the resin before the amount of the optical feedback detected exceeds the aforementioned threshold.

Therefore, it is important to detect degradation of a resin that fixes an optical fiber or the like in order to prevent a failure of a laser apparatus. However, such a resin is provided at an invisible location from an outside of the structure in most cases. Thus, it is difficult to identify the degradation of the resin. Furthermore, even if the resin is visible from an outside of the structure, some type of degradation of the resin may not be recognized by visual inspection. In such a case, it is difficult to accurately detect the degradation of the resin.

### PATENT LITERATURE

Patent Literature 1: JP 2017-21099 A

### SUMMARY

One or more embodiments provide a laser apparatus and a method that can effectively detect degradation of a resin that fixes an optical fiber in place.

According to one or more embodiments, there is provided a laser apparatus capable of effectively detecting degradation of a resin that fixes an optical fiber. The laser apparatus has an optical fiber through which a laser beam propagates, a resin that fixes the optical fiber, a sound sensor configured to detect a sound produced by the resin that shrinks when a power of light propagating through the optical fiber decreases from its peak value, a storage unit configured to store a threshold (threshold value) relating to a sound produced when the resin shrinks, and a comparison determination part operable to compare a detected value representative of the sound detected by the sound sensor to the threshold stored in the storage unit and determine that the resin has been degraded when the detected value exceeds the threshold. The laser apparatus may have at least one fiber laser connected to the optical fiber.

According to one or more embodiments, there is provided a method capable of effectively detecting degradation of a resin that fixes an optical fiber. This method includes setting a certain threshold, detecting a sound produced by the resin that shrinks when a power of light propagating through the optical fiber decreases from its peak value, comparing a detected value representative of the detected sound to the threshold, and determining that the resin has been degraded when the detected value exceeds the threshold.

According to one or more embodiments, there is provided a method capable of detecting a power of light propagating through an optical fiber. This method includes detecting a sound produced when a resin that fixes an optical fiber shrinks and, based on the detected sound, detecting that a power of light propagating through the optical fiber decreases from its peak value.

### BRIEF DESCRIPTION OF THE DRAWINGS

FIG. 1A is a diagram explanatory of a phenomenon in which a sound is produced by an optical feedback.

FIG. 1B is a diagram explanatory of a phenomenon in which a sound is produced by an optical feedback.

FIG. 2 is a diagram schematically showing a laser apparatus according to one or more embodiments.

FIG. 3 is a diagram schematically showing an output combiner and a sound sensor in the laser apparatus illustrated in FIG. 2.

FIG. 4A is a graph showing voltage data representative of a reference sound detected by the sound sensor illustrated in FIG. 2 for determining a threshold.

FIG. 4B is a graph showing a frequency spectrum obtained by performing a discrete Fourier transform on the voltage data illustrated in FIG. 4A.

FIG. 5 is a flow chart showing an operation of the laser apparatus illustrated in FIG. 2.

FIG. 6A is a graph showing voltage data representative of a sound detected by the sound sensor illustrated in FIG. 2 during operation.

FIG. 6B is a graph showing a frequency spectrum obtained by performing a discrete Fourier transform on the voltage data illustrated in FIG. 6A.

### DETAILED DESCRIPTION

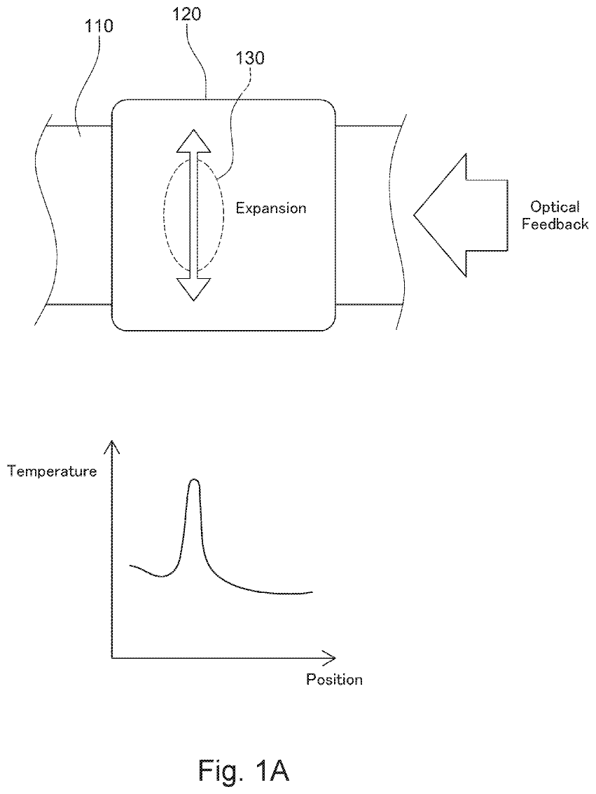

Embodiments of the present invention will be described in detail below with reference to FIGS. 1A to 6B. In FIGS. 1A to 6B, the same or corresponding components are denoted by the same or corresponding reference numerals and will not be described below repetitively. Furthermore, in FIGS. 1A to 6B, the scales or dimensions of components may be exaggerated, or some components may be omitted. Furthermore, in the following description, a laser apparatus using a fiber laser according to one or more embodiments will be explained as an example of a laser apparatus. Nevertheless, one or more embodiments may be applicable to any laser apparatus that outputs a laser beam.

The inventor has diligently studied a method of effectively detecting degradation of a resin that is caused by an optical feedback in order to prevent the aforementioned failure of a laser apparatus that would be caused by an optical feedback. As a result, the inventor has found that an optical feedback causes a resin to generate heat and to expand and that, when the power of the optical feedback decreases from its peak value, the resin shrinks so that a sound is produced.

As shown in FIG. 1A, when an optical feedback propagates through an optical fiber 110, a portion of the optical feedback is absorbed, for example, in a resin 120 that fixes the optical fiber 110 within an output combiner. Thus, the temperature of the portion 130 of the resin 120 locally increases as shown in a graph depicted at a lower side of FIG. 1A. Accordingly, the portion 130 of the resin 120 extends by thermal expansion. Then, when the optical feedback ceases or the amount of the optical feedback decreases, the heat of the thermally expanded portion 130 of the resin 120 diffuses therearound, so that the temperature of the portion 130 decreases as shown in a graph depicted at a lower side of FIG. 1B. Thus, the thermally expanded portion 130 shrinks back to the initial state. Such a cycle of local expansion and shrinkage of the resin 120 vibrates a structure where the resin 120 has been fixed (e.g., an output combiner). As a result, a sound is produced. In other words, a sound is produced when the power of the optical feedback propagating through the optical fiber 110 decreases from its peak value. Accordingly, whether the power of the optical feedback propagating through the optical fiber 110 decreases from its peak value can be detected by detection of a sound (hereinafter referred to as “resin shrinkage sound”) produced by shrinkage of the resin 120 that fixes the optical fiber 110.

Additionally, the inventor has found that the strength of the resin shrinkage sound increases as the resin 120 is degraded. Therefore, when the strength of the resin shrinkage sound from the resin 120 that should be considered to be degraded is set as a threshold, then the degradation of the resin 120 can be determined by detecting whether or not the strength of the resin shrinkage sound produced from the resin 120 exceeds the threshold.

The frequency of a resin shrinkage sound being produced depends upon the natural frequency, which is defined by a location where the resin 120 shrinks and expands, a structure in the vicinity of the resin 120, a method of fixing the resin 120, and the like. Accordingly, if a frequency analysis is conducted on a resin shrinkage sound produced upon expansion and shrinkage of the resin 120 so as to acquire, for example, an amplitude at a specific frequency or in a specific frequency band that corresponds to the natural frequency, then the degradation of the resin 120 can be determined more accurately by comparison of the amplitude with the threshold.

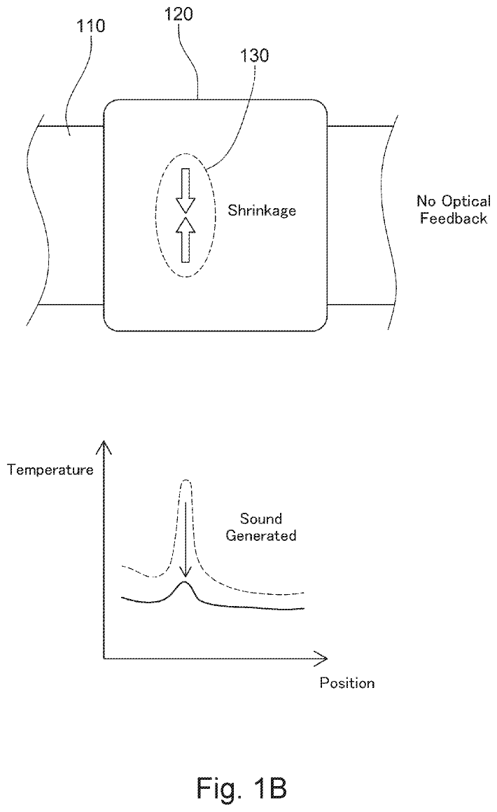

FIG. 2 is a diagram schematically showing a laser apparatus 1 using such a resin degradation detection method. As shown in FIG. 2, the laser apparatus 1 has a plurality of fiber laser units 10 as laser light sources, optical fibers 12 connected to the respective fiber laser units 10, an output combiner 20 connected to the optical fibers 12, an optical fiber 22 connected to the output combiner 20, a process head 30 connected to the optical fiber 22, a controller 40 operable to control an operation of the laser apparatus 1, and a sound sensor 50 located near the output combiner 20.

Each of the fiber laser units 10 includes an optical cavity therein. Thus, each of the fiber laser units 10 is configured to output a laser beam amplified by the optical cavity. The laser beams outputted from those fiber laser units 10 propagate through the respective optical fibers 12. Those laser beams are combined by the output combiner 20 and outputted to one optical fiber 22. The combined laser beam is delivered through the optical fiber 22 to the process head 30 and directed as a focused laser beam L to a workpiece 100 by an optical system within the process head 30.

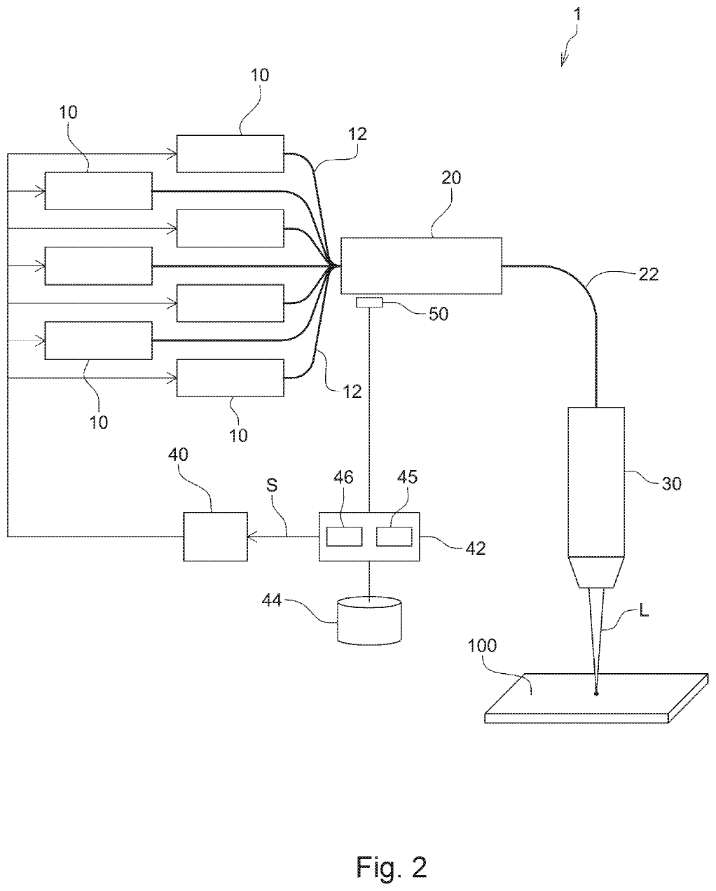

FIG. 3 is a diagram schematically showing the output combiner 20 and the sound sensor 50. As shown in FIG. 3, the output combiner 20 includes a fiber accommodation portion 26 with a groove 24 defined therein, which accommodates the input optical fibers 12 and the output optical fiber 22 therein. A bundle of the multiple optical fibers 12 extending from the fiber laser units 10 is fixed to the fiber accommodation portion 26 on an end of the groove 24 by a resin 28. The optical fiber 22 extending to the process head 30 is fixed to the fiber accommodation portion 26 on another end of the groove 24 by a resin 29. In one or more embodiments, the sound sensor 50 is located near the resin 28.

A certain length of a coating material has been removed from an end of each of the optical fibers 12 along a longitudinal direction of the optical fiber 12. Thus, claddings 12A of the optical fibers 12 are exposed. Similarly, a certain length of a coating material has been removed from an end of the optical fiber 22 along a longitudinal direction of the optical fiber 22, and a cladding 22A of the optical fiber 22 is thus exposed. Those exposed portions of the claddings 12A and the cladding 22A are located between the resin 28 and the resin 29. The diameter of the claddings 12A of the optical fibers 12 are reduced in a tapered manner so as to match the diameter of the cladding of the optical fiber 22. The tapered portion of the optical fibers 12 and the cladding 22A of the optical fiber 22 are connected to each other by fusion splice.

For example, as shown in FIG. 2, when the focused laser beam L is emitted perpendicular to a surface of the workpiece 100 or the like, a portion of the focused laser beam L may be reflected from the surface of the workpiece 100 so as to return to an interior of the laser apparatus 1 from the process head 30. Such an optical feedback introduced into the laser apparatus 1 may reach the output combiner 20, and a portion of the optical feedback may be absorbed, for example, in the resin 28 that fixes the optical fiber 12. Thus, the resin 28 may be degraded. In one or more embodiments, degradation of the resin 28 is detected by the aforementioned method.

The sound sensor 50 is located near the resin 28 and configured to detect a sound (resin shrinkage sound) produced when the resin 28 expands and shrinks due to heat caused by the optical feedback. The sound sensor 50 is configured to detect a sound at a predetermined sampling rate and externally output the detected sound, for example, as a variation of a voltage (voltage data). Any sensor capable of detecting a resin shrinkage sound can be used for the sound sensor 50. Various kinds of sound sensors including an electrodynamic sound sensor, an electrostatic sound sensor (condenser microphone), a piezoelectric sound sensor (piezoelectric microphone), and the like may be used for the sound sensor 50.

As shown in FIG. 2, the laser apparatus 1 includes a processing unit (processor) 42 connected to the sound sensor 50 and a storage unit (storage) 44 formed of a hard disk, ROM, RAM, or the like. The storage unit 44 stores a threshold relating to the resin shrinkage sound of the resin 28. The details of the threshold will be described later. The voltage data are inputted to the processing unit 42 from the sound sensor 50.

The processing unit 42 includes an analysis part 45 operable to perform a discrete Fourier transform on the voltage data from the sound sensor 50 for frequency analysis and a comparison determination part 46 operable to compare an amplitude (detected value) at a specific frequency in a frequency spectrum obtained by the analysis part 45 to the threshold stored in the storage unit 44. The comparison determination part 46 is configured to determine that the resin 28 has been degraded and to send a resin degradation signal S to the controller 40 when an amplitude at the specific frequency exceeds the threshold.

Now the threshold stored in the storage unit 44 will be described. The threshold may be determined and stored in the storage unit 44 before the resin 28 has been degraded. For example, the threshold is determined in the following manner.

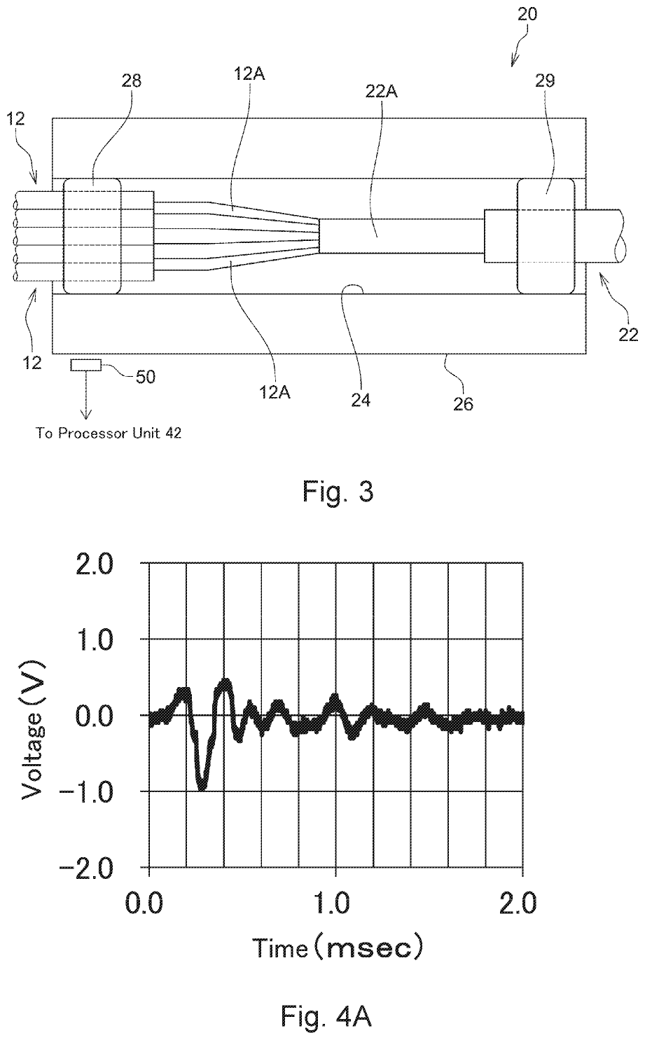

First, a pulsed beam having a certain power is introduced into the laser apparatus 1 from the process head 30 before the resin 28 has been degraded. Thus, the resin 28 is heated so that the temperature of the resin 28 changes. Therefore, the resin 28 expands and shrinks so as to produce a resin shrinkage sound (reference sound). The sound sensor 50 detects the reference sound at a predetermined sampling rate and inputs its voltage data to the analysis part 45 of the processing unit 42. At that time, the sound sensor 50 acquires voltage data, for example, as illustrated in FIG. 4A.

The analysis part 45 of the processing unit 42 stores the voltage data as illustrated in FIG. 4A, which has been sent from the sound sensor 50, for a predetermined period of time and performs a discrete Fourier transform on the data. As a result, a frequency spectrum as illustrated in FIG. 4B is acquired. In this frequency spectrum, a threshold is determined to be a value that exceeds an amplitude at a specific frequency (frequency of interest) that corresponds to, for example, the aforementioned natural frequency. For example, in the frequency spectrum illustrated in FIG. 4B, an amplitude at about 2.1 kHz is about 18 mV. Therefore, a threshold is determined to be 35 mV. The threshold thus determined (35 mV) is stored in the storage unit 44. Various factors including the aforementioned natural frequency determine what frequency is a frequency of interest and how large the threshold is as compared to an amplitude at the frequency of interest.

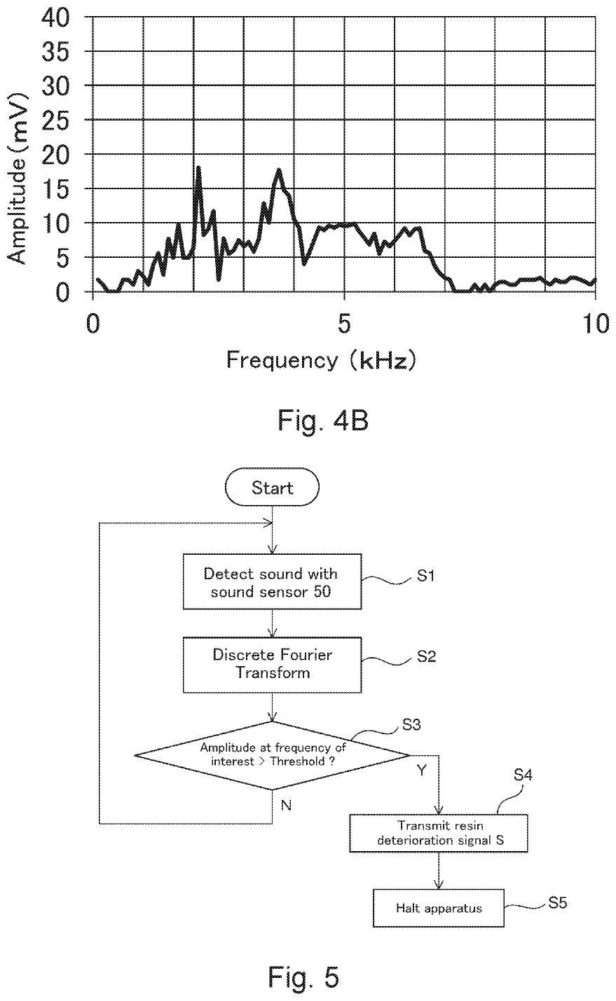

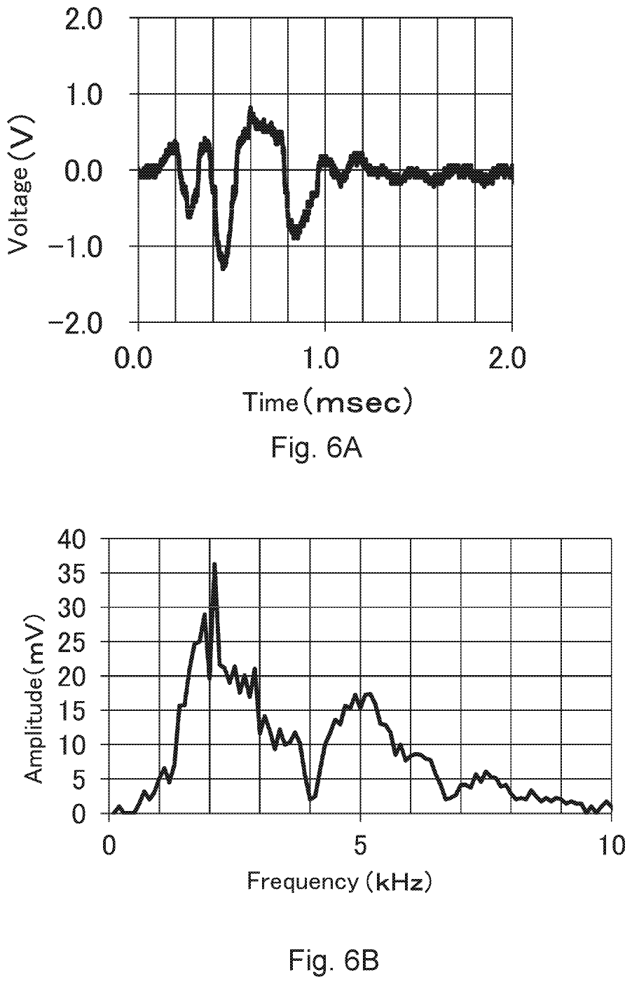

Now a normal operation of the laser apparatus 1 will be described. FIG. 5 is a flow chart showing an operation of the laser apparatus 1. As shown in FIG. 5, when the laser apparatus 1 is in normal operation, the sound sensor 50 detects a sound at a predetermined sampling rate and inputs the detected sound as voltage data to the analysis part 45 of the processing unit 42 (Step S1). For example, voltage data as shown in FIG. 6A is acquired by the sound sensor 50 and inputted to the analysis part 45 of the processing unit 42. The sampling rate of the sound sensor 50 needs to be higher than twice the aforementioned frequency of interest in accordance with the sampling theorem. Thus, the sampling rate of the sound sensor 50 needs to be higher than 4.2 kHz in the aforementioned example.

The analysis part 45 of the processing unit 42 stores the inputted voltage data for a predetermined period of time and performs a discrete Fourier transform on the voltage data (Step S2). Some period of time may be enough for storing the voltage data. For example, the period of time for which the voltage data have been stored may be 10 milliseconds. This discrete Fourier transform provides a frequency spectrum. The comparison determination part 46 determines whether or not the amplitude of the frequency spectrum at the frequency of interest (2.1 kHz) exceeds a threshold stored in the storage unit 44 (35 mV) (Step S3). If the amplitude at the frequency of interest does not exceed the threshold, the procedure returns to the sound sampling (Step S1). If the amplitude at the frequency of interest exceeds the threshold, the comparison determination part 46 determines that the resin 28 has been degraded and sends a resin degradation signal S to the controller 40 (Step S4).

When a discrete Fourier transform is performed on the voltage data shown in FIG. 6A, a frequency spectrum as shown in FIG. 6B can be obtained. The amplitude of this frequency spectrum at the frequency of interest (2.1 kHz) is about 37 mV and exceeds the threshold stored in the storage unit 44 (35 mV). Therefore, the comparison determination part 46 determines that the resin 28 has been degraded and send a resin degradation signal S to the controller 40.

The controller 40 that has received the resin degradation signal S stops the operation of the laser apparatus 1, for example, by stopping an electric current supplied to the fiber laser units 10 (Step S5). Thus, the operation of the laser apparatus 1 can be stopped before the laser apparatus 1 experiences a failure. Furthermore, the controller 40 may decrease an electric current supplied to the fiber laser units 10 or otherwise notify an operator of degradation of the resin 28 through another user interface (e.g., a rotating lamp, a display, or means for external communication).

Thus, according to one or more embodiments, degradation of a resin can be detected by using a resin shrinkage sound. Therefore, degradation that could not be detected by visual inspection can be detected. Furthermore, even if the sound sensor 50 is located outside of the output combiner 20, the resin shrinkage sound of the resin 28 can be detected. Accordingly, even if the resin 28 is invisible from the outside of the output combiner 20, degradation of the resin 28 can be detected.

Furthermore, since a threshold that reflects a state prior to degradation of the resin 28 is used in the above embodiments, the current state can be compared to the state prior to degradation of the resin 28 when the laser apparatus 1 is operated. Accordingly, degradation of the resin can be detected more accurately.

In the above embodiments, the comparison determination part 46 compares an amplitude of the frequency spectrum at a specific frequency to the threshold. However, an integrated value of amplitudes within a specific frequency band may be used instead of an amplitude at a specific frequency. Furthermore, in the above embodiments, the analysis part 45 of the processing unit 42 performs a discrete Fourier transform on data representative of a sound detected by the sound sensor 50 (voltage data). However, the frequency analysis using a discrete Fourier transform may not be required. A detected value, such as a voltage value representative of a sound detected by the sound sensor 50, may be compared to the threshold. Moreover, the detected value representative of a sound detected by the sound sensor 50 may be any physical quantity including a voltage value and an electric current value.

Moreover, the processing unit 42, the storage unit 44, and the like as described above may be provided integrally with the controller 40, which controls an operation of the laser apparatus 1, or may be provided separately from the controller 40.

The above embodiments describe examples where degradation of resin 28 in the output combiner 20 is to be detected. Nevertheless, one or more embodiments can be applied to a resin provided at any location as long as the resin may be degraded due to the laser beam. For example, one or more embodiments can be used to detect degradation of a resin that fixes an optical fiber in a structure that removes a cladding mode.

Although only a limited number of embodiments have been described, the scope of the present invention is not limited to the aforementioned embodiments. It should be understood that various different embodiments may be devised without departing from the scope of the present invention.

As described above, according to one or more embodiments, there is provided a laser apparatus capable of effectively detecting degradation of a resin that fixes an optical fiber. The laser apparatus has an optical fiber through which a laser beam propagates, a resin that fixes the optical fiber, a sound sensor configured to detect a sound produced by the resin that shrinks when a power of light propagating through the optical fiber decreases from its peak value, a storage unit configured to store a threshold relating to a sound produced when the resin shrinks, and a comparison determination part operable to compare a detected value representative of the sound detected by the sound sensor to the threshold stored in the storage unit and determine that the resin has been degraded when the detected value exceeds the threshold. The laser apparatus may have at least one fiber laser connected to the optical fiber.

With this configuration, degradation of a resin can be detected by using a sound (resin shrinkage sound) produced by the resin that shrinks when a power of light propagating through the optical fiber decreases from its peak value. Thus, since degradation of the resin can be detected by using such a resin shrinkage sound, degradation that could not be detected by visual inspection can be detected. Furthermore, even if the laser apparatus has a structure where the resin is invisible from the outside of the structure, degradation of the resin can be detected. Moreover, since degradation of the resin can be detected, any necessary measures such as stop and alert can be taken before the laser apparatus experiences a failure.

The threshold may relate to an amplitude of a sound at a specific frequency or in a specific frequency band. The laser apparatus according to one or more embodiments may further include an analysis part operable to perform a frequency analysis on data representative of the sound detected by the sound sensor and output an amplitude at the specific frequency or in the specific frequency band as the detected value to the comparison determination part. Thus, since the comparison with the threshold employs the results obtained by a frequency analysis on data representative of the resin shrinkage sound, degradation of the resin can be detected more accurately.

One or more embodiments provide a method capable of effectively detecting degradation of a resin that fixes an optical fiber. This method includes setting a certain threshold, detecting a sound produced by the resin that shrinks when a power of light propagating through the optical fiber decreases from its peak value, comparing a detected value representative of the detected sound to the threshold, and determining that the resin has been degraded when the detected value exceeds the threshold.

According to this method, degradation of a resin can be detected by using a sound (resin shrinkage sound) produced by the resin that shrinks when a power of light propagating through an optical fiber decreases from its peak value. Thus, since degradation of the resin can be detected by using such a resin shrinkage sound, degradation that could not be detected by visual inspection can be detected. Furthermore, even if the laser apparatus has a structure where the resin is invisible from the outside of the structure, degradation of the resin can be detected.

The threshold may relate to an amplitude of a sound at a specific frequency or in a specific frequency band. In this case, a frequency analysis on data representative of the detected sound may be performed and an amplitude at the specific frequency or in the specific frequency band as the detected value may be compared to the threshold, upon the comparing the detected value to the threshold. Thus, since the comparison with the threshold employs the results obtained by a frequency analysis on data representative of the resin shrinkage sound, degradation of the resin can be detected more accurately.

Before the resin is degraded, a reference sound produced by the resin that shrinks when a power of light propagating through the optical fiber decreases from its peak value may be detected, and the threshold may be determined based on the detected reference sound. Use of such a threshold enables comparison with a state prior to degradation. Therefore, degradation of the resin can be detected more accurately.

According to one or more embodiments, there is provided a method capable of detecting a power of light propagating through an optical fiber. This method includes detecting a sound produced when a resin that fixes an optical fiber shrinks and, based on the detected sound, detecting that a power of light propagating through the optical fiber decreases from its peak value.

According to this method, the fact that a power of light propagating through an optical fiber decreases from its peak value can be detected by using a sound produced when a resin that fixes the optical fiber shrinks.

According to one or more embodiments, degradation of a resin that fixes an optical fiber can be detected by using a sound produced when the resin shrinks.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGN LIST

1 Laser apparatus
10 Fiber laser unit
12 Optical fiber
12A Cladding
20 Output combiner
22 Optical fiber
22A Cladding
24 Groove
26 Fiber accommodation portion
30 Process head
40 Controller
42 Processing unit
44 Storage unit
45 Analysis part
46 Comparison determination part
50 Sound sensor
100 Workpiece
L Focused laser beam
S Resin degradation signal

1. A laser apparatus comprising:
an optical fiber through which a laser beam propagates;
a resin that fixes the optical fiber in place;
a sound sensor that detects a sound produced by the resin that shrinks when power of light propagating through the optical fiber decreases from its peak value;
a storage that stores a threshold value; and
a comparison determination part that:
compares the threshold value to a detected value representative of the sound detected by the sound sensor; and
determines that the resin has been degraded when the detected value exceeds the threshold value.

2. The laser apparatus as recited in claim 1, wherein
the threshold value relates to an amplitude of sound at a specific frequency or in a specific frequency band, and
the laser apparatus further comprises an analysis part that performs a frequency analysis on data representative of the sound detected by the sound sensor and outputs, to the comparison determination part, an amplitude at the specific frequency or in the specific frequency band as the detected value.

3. The laser apparatus as recited in claim 1, further comprising at least one fiber laser connected to the optical fiber.

4. A method of detecting degradation of a resin that fixes an optical fiber, the method comprising:
setting a certain threshold value;
detecting a sound produced by the resin that shrinks when power of light propagating through the optical fiber decreases from its peak value;
comparing the threshold value to a detected value representative of the detected sound; and
determining that the resin has been degraded when the detected value exceeds the threshold value.

5. The method as recited in claim 4, wherein
the threshold value relates to an amplitude of sound at a specific frequency or in a specific frequency band, and
the comparing the threshold value to the detected value comprises performing a frequency analysis on data representative of the detected sound and comparing the threshold value to an amplitude at the specific frequency or in the specific frequency band as the detected value.

6. The method as recited in claim 4, wherein the setting the threshold value comprises:
detecting a reference sound produced by the resin that shrinks when the power of light propagating through the optical fiber decreases from its peak value before the resin is degraded, and
determining the threshold value based on the detected reference sound.

7. A detection method of an optical power, the detection method comprising:
detecting a sound produced when a resin that fixes an optical fiber in place shrinks; and
based on the detected sound, detecting that a power of light propagating through the optical fiber decreases from its peak value.

8. The laser apparatus as recited in claim 2, comprising at least one fiber laser connected to the optical fiber.

9. The method as recited in claim 5, wherein the setting the threshold value comprises:
detecting a reference sound produced by the resin that shrinks when a power of light propagating through the optical fiber decreases from its peak value before the resin is degraded, and
determining the threshold value based on the detected reference sound.
